(19) United States
(12) Patent Application Publication
(10) Pub. No.: US 2015/0103280 A1
(43) Pub. Date: Apr. 16, 2015

(54) INTELLIGENT ELECTRONIC SUNBLIND

(71) Applicant: COREMATE TECHNICAL CO., LTD., Taoyuan County (TW)

(72) Inventor: Robert WANG, TAOYUAN COUNTY (TW)

(73) Assignee: COREMATE TECHNICAL CO., LTD., Taoyuan County (TW)

(21) Appl. No.: 14/055,040

(22) Filed: Oct. 16, 2013

(51) Int. Cl. G02F 1/13; G02F 1/133

(52) U.S. Cl. CPC G02F 1/1313; G02F 1/13306
USPC 349/16

(57) ABSTRACT

An intelligent electronic sunblind includes an integral glass plate and a liquid crystal film attached on the glass plate. The liquid crystal film is formed with several display regions, and the liquid crystal film of the display region is cut into strips or is primarily formed with a strips shape, with the display regions abutting each other. A controller is installed between the display regions and a power source and connected with an input unit that functions to transmit signals and produce power control to the controller. The controller controls the liquid crystal film of the display regions to be electrically connected or electrically disconnected to make the liquid crystal film respectively become transparent or opaque for attaining an effect of simulating different states of partially shading light of a conventional window curtain.

### BACKGROUND OF THE INVENTION

1. Field of the Invention

This invention relates to an electronic sunblind, particularly to one having a liquid crystal film attached to the surface of a glass plate and divided into several display regions, which can be respectively controlled to be electrically connected or disconnected to enable each liquid crystal film on the glass plate to become pervious to light or opaque independently for attaining an effect of shading light partially.

2. Description of the Prior Art

A conventional window curtain, such as a Venetian blind, a Roman shade and a pleated blind, is a common article with excellent shading function and is provided with a control mechanism for controlling a shading area. The window curtain can be controlled to obstruct light with a large range when outside light is excessively strong, or to block off light with a comparatively small range when light is not too strong for regulation of environmental luminosity.

In the wake of progress of science and technology, an electronic sunblind emerges as the times require. The conventional electric sunblind is provided with a liquid crystal film on a glass plate, and the liquid crystal film can be electrically connected or disconnected to become transparent or opaque for achieving an effect of shading sunlight. However, the conventional electronic sunblind has no function of partially shading light; therefore, the conventional electronic sunblind has to be used in cooperation with a curtain if necessary, thus resulting in inconvenience in use.

In view of this situation, the inventor of this invention has been engaged in intensive study of the drawback of the conventional electronic sunblind and the problems to be faced and endeavored to research and devise this invention.

### SUMMARY OF THE INVENTION

The objective of this invention is to offer an intelligent electronic sunblind having a glass plate provided thereon with a liquid crystal film able to be controlled to make a part pervious to light or opaque for attaining an effect of shading light partially. The intelligent electronic sunblind in the present invention includes an integral glass plate having its surface provided with a liquid crystal film, which is connected with a power source and divided into several display regions abutting each other. A controller is installed between the display regions and the power source for respectively controlling the display regions to make electrical connection or disconnection. An input unit is connected with the controller for transmitting signals and producing power control to the controller to enable the controller to control the liquid crystal film to be pervious to light or become opaque, thus achieving effects of shading light and regulating lighting.

The input unit of the intelligent electronic sunblind of this invention can be human body sensing, operation buttons, touch panel control and wireless remote control. The input unit functions to transmit signals to the controller and after receiving the signals, the controller will turn on or off the power source of the liquid crystal film to control the liquid crystal film to be pervious to light or become opaque. Therefore, the intelligent electronic sunblind of this invention is needless to provide conventional control mechanism for folding and turning a curtain and has function of regulation of luminosity for achieving effects of shading light and regulating lighting, able to effectively ameliorate the conventional window curtains.

### BRIEF DESCRIPTION OF DRAWINGS

This invention will be better understood by referring to the accompanying drawings, wherein:

FIG. 1 is an exploded perspective view of a first preferred embodiment of a liquid crystal film and a glass plate of an intelligent electronic sunblind in the present invention;

FIG. 2 is a block diagram of the first preferred embodiment of the intelligent electronic sunblind in the present invention;

FIG. 3 is a block diagram of the first preferred embodiment of the intelligent electronic sunblind in the present invention, showing that the display regions of the liquid crystal film are arranged horizontally;

FIG. 4 is a schematic view of the intelligent electronic sunblind assembled on the windshield of an automobile and not yet used for shading light in the present invention;

FIG. 5 is a schematic view of the intelligent electronic sunblind assembled on the windshield of an automobile and used for partially obstructing the sunlight in the present invention;

FIG. 6 is a schematic view of the intelligent electronic sunblind assembled on an automobile window that is not yet closed in the present invention;

FIG. 7 is a schematic view of the intelligent electronic sunblind assembled on an automobile window, illustrating that the automobile window is closed but the intelligent electronic sunblind is not yet used for shading light;

FIG. 8 is a schematic view of the intelligent electronic sunblind applied to an automobile window, showing that the window is closed and the electronic sunblind partially obstructs the sunlight;

FIG. 9 is a schematic view of a second preferred embodiment of an input unit of an intelligent electronic sunblind in the present invention; and

FIG. 10 is an exploded perspective view of the second preferred embodiment of an intelligent electronic sunblind having a liquid crystal film and two glass plates combined together in the present invention.

### DETAILED DESCRIPTION OF THE PREFERRED EMBODIMENT

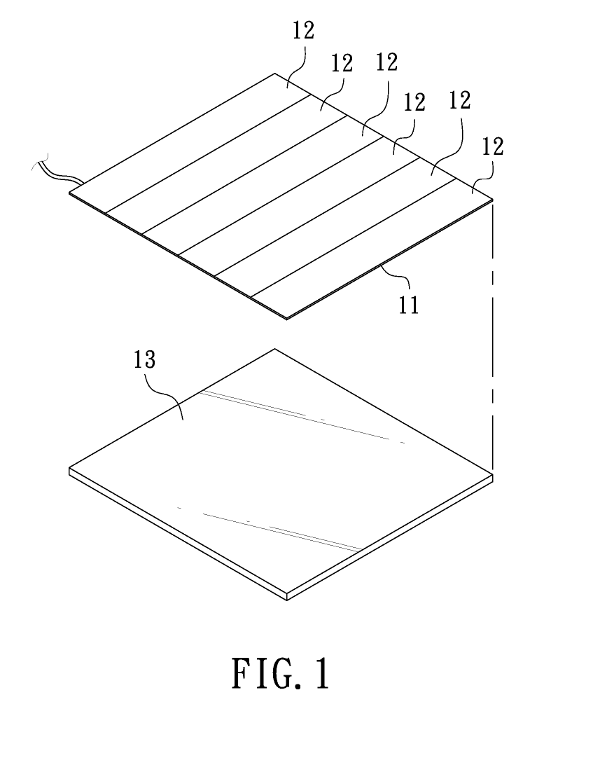

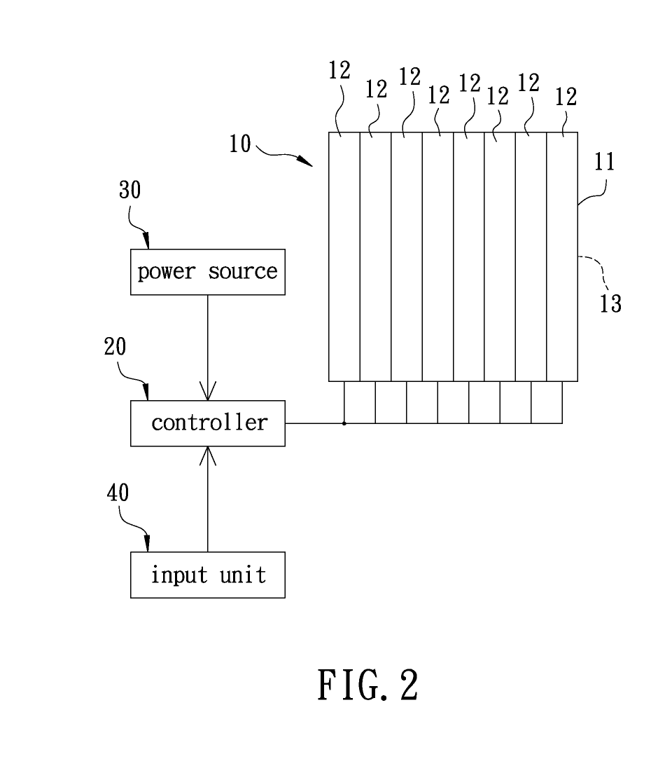

A first preferred embodiment of an intelligent electronic sunblind 10 in the present invention, as shown in FIGS. 1 and 2, includes a first glass plate 13, a liquid crystal film 11, a power source 30, a controller 20 and an input unit 40 as main components combined together.

The first glass plate 13 made of transparent glass can be installed at the window of a home or used for partitioning a bathroom or an office, or assembled on the window or the windshield of an automobile. The first glass plate 13 means an integral glass plate formed in a frame (not shown).

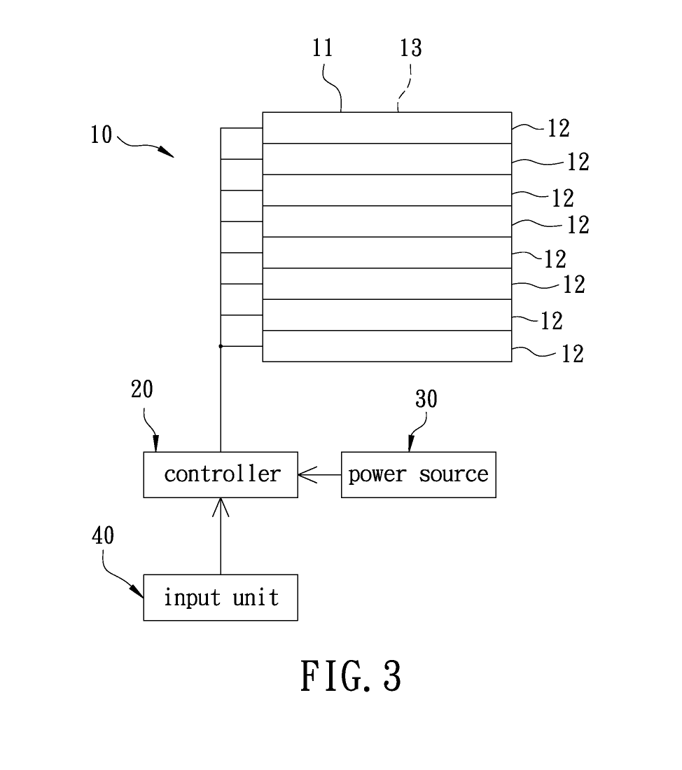

The liquid crystal film 11 can be attached to the first glass plate 13 by coating or pasting. The glass plate 13 can be an integral glass plate or a glass plate formed in a single frame. The liquid crystal film 11 will be transparent when the liquid crystal film is not electrically connected and on the contrary, the liquid crystal film 13 will become opaque when it makes electrical connection. Further, the liquid crystal film 11 is divided into several display regions 12, that is, the liquid crystal film of the display regions is formed into a strip shape by cutting or is primarily formed with a strip shape to make the display regions present several strip shapes and abut each other. In this preferred embodiment, the display regions 12 of the liquid crystal film 11 are arranged vertically, but the display regions 12 of the liquid crystal film 11 can also be arranged horizontally according to needs, as shown in FIG. 3.

The power source 30 is connected to the liquid crystal film 11 for supplying the liquid crystal film 11 with electric current to keep the liquid crystal film 11 in an opaque state. The power source 30 can be utility power, solar power or battery power and the power source 30 can be a wireless induction type or a wired connection type for supplying electricity.

The controller 20 is installed between the display regions 12 of the liquid crystal film 11 and the power source 30 and respectively connected with the display regions 12 for controlling the power source 30 to supply or stop supplying electric current for the display regions 12. To state in full detail, the controller 20 can respectively control the display regions 12 of the liquid crystal film 11 to be pervious to light or become opaque and further control incidence of light. In this preferred embodiment, the mode of having the controller 20 connected with the liquid crystal film 11 is wired power supply and control, but a mode of wireless power supply and control can also be employed.

The input unit 40 is connected with the controller 20 for transmitting signals to the controller 20 and when receiving signals, the controller 20 will control the power source 30 of the display regions 12 to be ON and OFF for regulating the liquid crystal film 11. In this preferred embodiment, the input unit 40 is a multistage operation button to enable the display regions 12 of the liquid crystal film 11 to be displayed respectively.

To control the liquid crystal film 11 to be pervious to light or to become opaque, have the input unit 40 transmitting signals to the controller 20 and simultaneously, the controller 20 will control the display regions 12 of the liquid crystal film 11 to make electrical connection or electrical disconnection. Thus, the display regions 12 of the liquid crystal film 11 can be respectively controlled to be pervious to light or to become opaque for producing an effect of partially shading light. In other words, the intelligent electronic sunblind of this invention can carry out regional control, able to ameliorate the function of regulating environmental luminosity of the conventional curtain and get rid of the defect that the conventional electronic window curtain is unable to carry out partial blocking of light and results in unevenness in environmental luminosity.

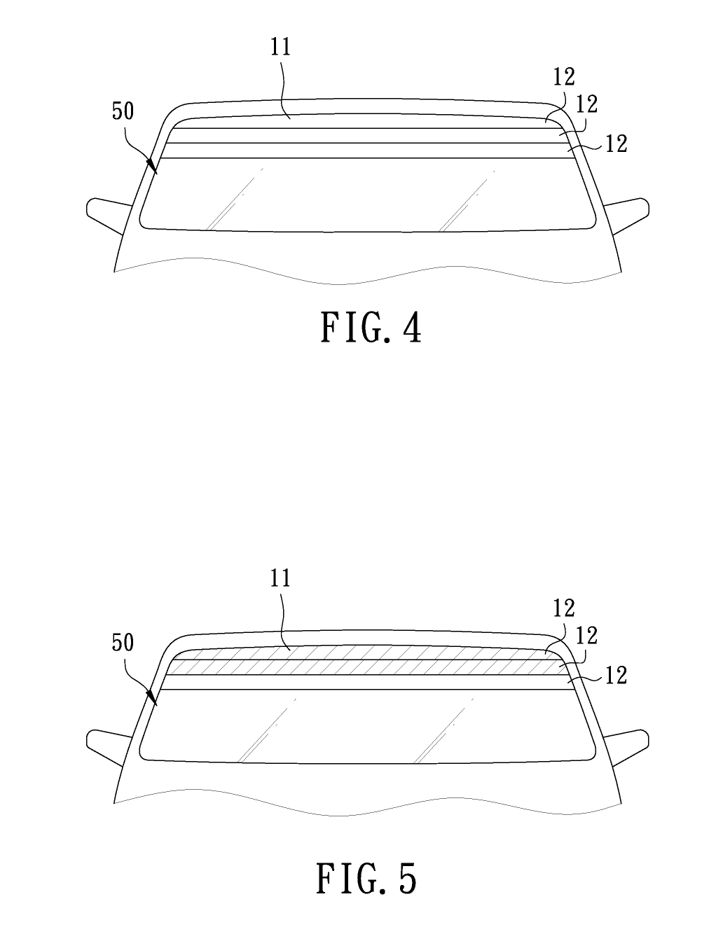

Referring to FIGS. 4 and 5, the intelligent electronic sun blind of this invention can be applied to the windshield of an automobile. FIG. 4 shows that the electronic sunblind is assembled on the windshield but not yet functions to shade light, while FIG. 5 shows that the electronic sunblind is employed for shading light. The liquid crystal film 11 of the electronic sunblind 10 is fixed on the front windshield 50 of an automobile, and the display regions 12 of the liquid crystal film 11 is strips-shaped, arranged horizontally and abutting each other on the front windshield. The display regions 12 can be controlled by the input unit 40 to become pervious to light or to be opaque for shading light when the automobile is running. Thus, to control the display regions 12, a user only has to control the input unit 40, not only attaining an effect of blocking sunlight, but also eliminating the shortcoming that the douser of the automobile has to be turned about manually.

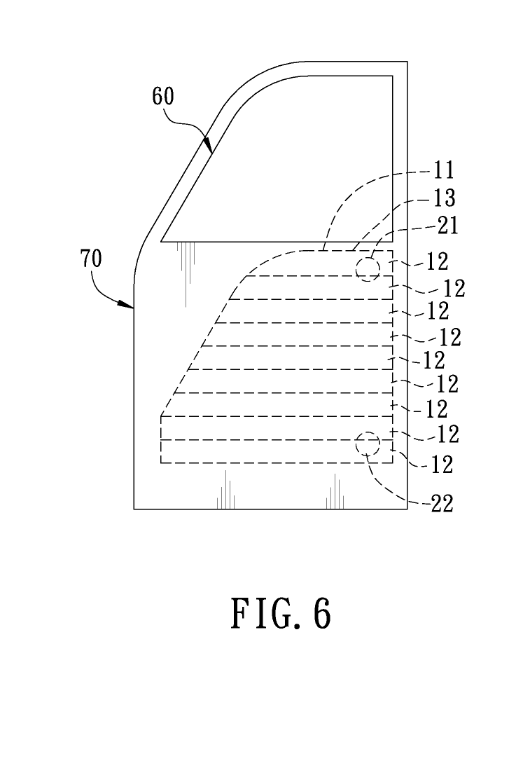

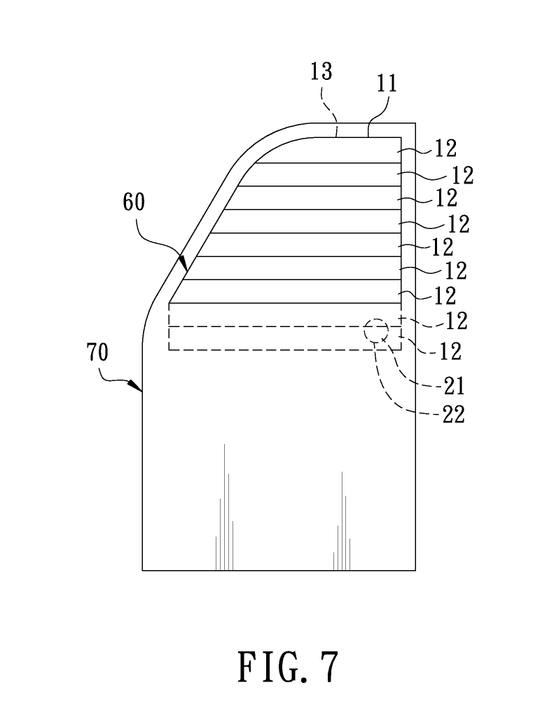

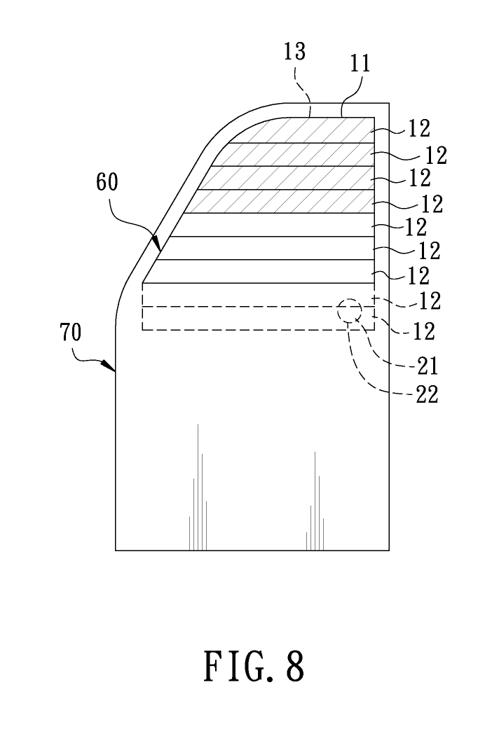

The intelligent electronic sunblind of this invention can be applied to the windows of an automobile, as shown in FIGS. 6-8. FIG. 6 shows that the electronic sunblind is applied to an automobile window that is not closed, FIG. 7 shows that the electronic sunblind is attached to an automobile window that is closed but the electronic sunblind is not yet used for blocking the sunlight and FIG. 8 shows that the electronic sunblind is fixed on an automobile window that is closed and the electronic sunblind functions to partially block the sunlight. In the FIGS. 6-8, the side door 70 of an automobile is formed with a window 60 provided therein with the first glass plate 13, which has its outer surface stuck with the liquid crystal film 11. The controller 20 is connected with the liquid crystal film 11 in a mode of wireless power supply and control, that is, the controller 20 is connected with a first electric induction coil 21, while the display regions 12 are collectively provided with a second electric induction coil 22 corresponding to the first electric induction coil 21. Thus, power wireless transmission can be carried out by mutually electric induction of the first and the second electric induction coils 21 and 22. The first electric induction coil 21 of the controller 20 is installed at a medial inner side of the vehicle side door 70, and the second electric induction coil 22 is correspondingly set on the liquid crystal film 11, and the mutually corresponding state of the first and the second electric induction coils 21 and 22 is able to produce electric induction and carry out power wireless transmission for smoothly controlling the display regions 12 to be pervious to light or to be opaque. Therefore, the intelligent electronic sunblind of this invention can not only attain effects of shading light and regulating lighting, but also properly regulate the display regions for respectively blocking light in accordance with a user's needs, thus able to improve the defect that conventional vehicle heat insulation stickers have no function of regulation of luminosity.

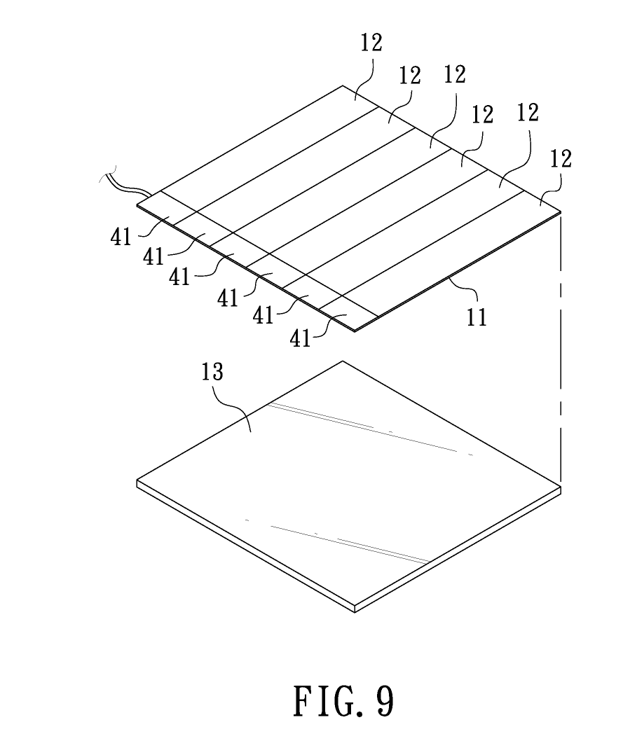

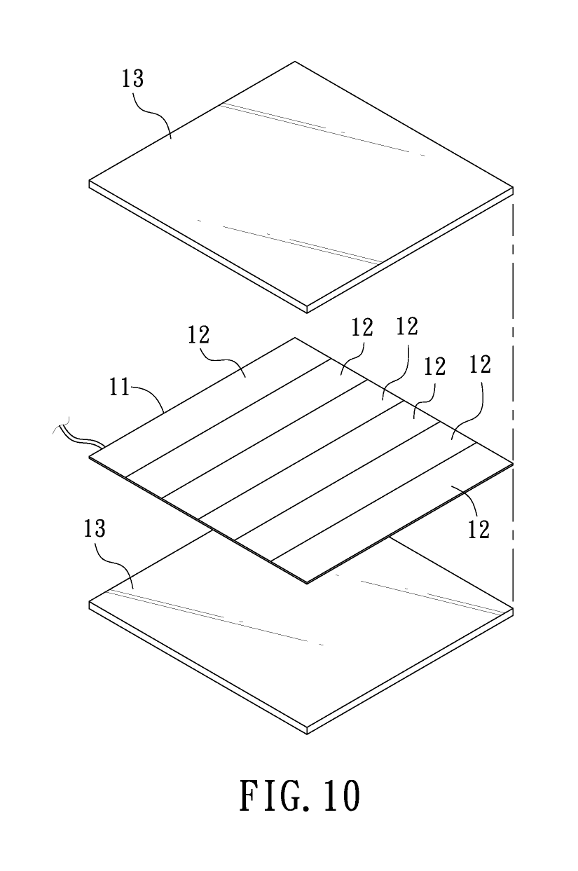

What is worth mentioning is that the input unit 40 of this invention can be operation buttons and also can be a mode of touch control, a mode of wireless remote control or a mode of sensor control. FIG. 9 shows a touch control type input unit 40 composed of a plurality of touch control panels 41 respectively and correspondingly assembled at the locations of the display regions 12 to be touched by a user's hand for inputting ON and OFF signals of the power source, namely, the area and number of the display regions 12 to be displayed can be controlled by a user's hand touching the touch control panels 41, hence having function of regulation of luminosity. The mode of wireless remote control is to transmit signals through infrared rays, laser light and Bluetooth for controlling the display region 12 of the liquid crystal film 11 to be transparent or opaque. The mode of sensing includes human body sensing, action sensing, temperature sensing and luminosity sensing by which signals can be transmitted for controlling the liquid crystal film 11 to be pervious to light or to be opaque.

A second preferred embodiment of the liquid crystal film and the glass plate in the present invention, as shown in FIG. 10, is to have a second glass plate 14 provided under the first glass plate 13 and the liquid crystal film 11 is sandwiched between the first glass plate 13 and the second glass plate 14 to let the first and the second glass plates 13 and 14 closely stuck on the liquid crystal film 11, thus able to protect the liquid crystal film 11 to prevent the liquid crystal film 11 from being scraped and damaged.

Aside from using the operation button as the input unit 40 of this invention, the input unit 40 also can be a mode of touch control, a mode of wireless remote control or a mode of control by sensors. Referring to FIG. 9, the mode of touch control is to have many touch control panels 41 respectively and correspondingly provided at the locations of the display regions 12 for a user's hand to touch and control the area and the number of the display regions 12 to be displayed for regulating the intensity of light. The mode of wireless remote control can employ infrared rays, laser light and Bluetooth to transmit signals for controlling the display regions 12 of the liquid crystal film 11 to be pervious to light or to be opaque. The mode of sensing consists of human body sensing, action sensing, temperature sensing and light intensity sensing, and such sensing signals can be transmitted for controlling the liquid crystal film 11 to be transparent or opaque.

While the preferred embodiments of the invention have been described above, it will be recognized and understood that various modifications may be made therein and the appended claims are intended to cover all such modifications that may fall within the spirit and scope of the invention.

What is claimed is:

1. An intelligent electronic sunblind comprising an integral first glass plate and a liquid crystal film, said liquid crystal film fixed on said first glass plate, said liquid crystal film connected with a power source, said liquid crystal film controlled to become transparent or opaque when said liquid crystal film is electrically connected or electrically disconnected; and characterized by,
said liquid crystal film divided into several display regions, said display regions abutting each other, a controller connected between said display regions and said power source, said controller connected with an input unit, said input unit transmitting signals and producing power control to said controller, said controller controlling each said display region to be pervious to light or become opaque independently for attaining an effect of partial shading of light.

2. The intelligent electronic sunblind as claimed in claim 1, wherein a second glass plate is provided under said first glass plate, and said liquid crystal film is sandwiched between said first glass plate and said second glass plate.

3. The intelligent electronic sunblind as claimed in claim 1, wherein said controller is connected with a first electric induction coil, and said display regions are collectively provided with a second electric induction coil corresponding to said first electric induction coil, electric induction produced between said first electric induction coil and said second electric induction coil able to carry out electric wireless transmission.

4. The intelligent electronic sunblind as claimed in claim 1, wherein said display regions are respectively strips-shaped and arranged in parallel vertically.

5. The intelligent electronic sunblind as claimed in claim 1, wherein said display regions are respectively strips-shaped and arranged in parallel horizontally.

6. The intelligent electronic sunblind as claimed in claim 1, wherein said input unit is an operation button.

7. The intelligent electronic sunblind as claimed in claim 1, wherein said input unit is a plurality of touch control panels respectively and correspondingly installed at the locations of said display regions.
